(19) United States
(12) Patent Application Publication
(10) Pub. No.: US 2003/0141686 A1
(43) Pub. Date: Jul. 31, 2003

(54) Braking assembly for manually operable carriage

(76) Inventor: Rob Willis, Wooford (AU)

Correspondence Address: SALTAMAR INNOVATIONS, 30 FERN LANE, SOUTH PORTLAND, ME, 04106, US

(21) Appl. No.: 10/204,280

(22) PCT Filed: Feb. 16, 2001
(86) PCT No.: PCT/AU01/00157

(30) Foreign Application Priority Data
Feb. 16, 2000 (AU) PQ 5630

(51) Int. Cl. B62B 3/00

(52) U.S. Cl. 280/47.34

(57) ABSTRACT

A vehicle, such as a wheelbarrow (1) brakes automatically when it runs downhill. A rearward pulling force, naturally applied to handles (4) of barrow (1) by a user when resisting acceleration of barrow (1) down a slope, results in rearward pivoting of, or rearward movement of sleeves on, the handles (4). Such movements are transmitted by linkage (11) (or by cable or hydraulically), to braking mechanism (10) acting on wheel (6).

### BACKGROUND

The present invention relates to braking assemblies and more particularly relates to a braking assembly for wheel mounted manually operable carriages such as but not limited to wheel barrows and the like. The invention will be primarily described with reference to its attachment to wheel barrows but it will be appreciated by those skilled in the art that the arrangement described in each embodiment is capable of attachment to other manually operable wheel mounted carriages.

### PRIOR ART

Wheel barrows or variations thereof have been known for many years. They are particularly useful in domestic and industrial applications for carrying materials in small quantities. Conventional wheel barrows comprise a wheel mounted platform including an undercarriage located towards a leading end, ground engaging supports towards a trailing end and a receptacle for mounting on the carriage and which holds materials to be transported. The undercarriage is generally sloped downwards from rear to front. This geometry allows the receptacle to be deepest at the front so that the majority of the load will be forward. This results in the centre of gravity being disposed forward in the direction of the wheel to assist operator handling.

In normal use, when a wheel barrow is operated on a horizontal surface the operator must lift then push to overcome its natural inertia. This requires some physical effort in both lifting and pushing. Due to the sloped geometry of the platform which is manifest when the barrow is at rest, the operator benefits from a mechanical advantage which is further enhanced once the undercarriage is lifted for use.

This mechanical advantage imparted by the natural slope of the undercarriage, although advantageous for optimum weight distribution, is a disadvantage when an operator must control the wheel barrow on a momentum grade which throws the center of gravity further forward and increases the tendency for natural acceleration. This can, particularly when the barrow carries a heavy load, make the wheel barrow difficult to control as the requisite pushing effort required in normal level or inclined operation is converted to a pulling effort to resist the runaway tendency. The difficulties for the operator are further compounded by the traditional geometry of the gripping handles which are normally an extension of the undercarriage. When operating the barrow on a momentum grade an operator is reliant for control on hand gripping friction forces which must increase as the slope increases. In extreme circumstances relaxation of the manual gripping forces could cause loss of control and escape of the barrow possibly resulting in damage or injury to persons or property. Wheel barrows are not traditionally adapted with braking mechanisms yet there are many instances in normal day to day use where the ability to effect braking would increase operator and public safety, significantly improve operator control and reduce operator fatigue.

### INVENTION

The present invention is primarily directed to eliminating the problems described above. More particularly the invention is directed to a braking assembly for hand operated wheel mounted carriages such as, but not limited to, wheel barrows and which is capable of converting an operating force, such as an acceleration generated in the carriage by momentum into a braking force using the natural gravitational effects applied to the carriage control handles when the carriage encounters the momentum grade. In one broad form the present invention comprises;

a braking assembly for a hand operated wheel mounted carriage such as a wheel barrow including an undercarriage mounted on at least one wheel and operating handles for controlling the attitude of said carriage, the braking assembly comprising: a braking mechanism capable of engagement with a wheel of said carriage to effect braking thereof, means operably linking said braking assembly to an actuating member associated with said operating handles; wherein said braking assembly moves between a non working state in which the braking mechanism is free of said at least one wheel and a working state in which the braking mechanism engages said at least one wheel to effect braking when said carriage encounters a slope.

Preferably, the braking assembly is operatively responsive to the effects of gravity generated by a slope. According to a preferred embodiment, the actuating member comprises a sleeve which engages one or both said gripping handles and is adapted to slidably move relative thereto.

In one broad form the present invention comprises;

a braking assembly for a hand operated wheel mounted carriage, the carriage including a support structure comprising a platform for receiving and supporting a load, an undercarriage including at least one wheel; the braking assembly comprising:

a control assembly for controlling said carriage and effecting braking by said braking assembly; the control assembly operably linked to a braking mechanism capable of engaging said at least one wheel of said carriage to effect braking thereof; wherein, said braking assembly moves between a non working state in which the braking mechanism is free of said at least one wheel and a working state in which the braking mechanism engages said at least one wheel to effect braking when said carriage encounters a slope. According to one embodiment the carriage comprises a wheel chair or wheel barrow.

In another broad form the present invention comprises:

a hand operated wheel mounted carriage, the carriage including a support structure comprising a platform for receiving and supporting a load, an undercarriage including at least one wheel; the carriage further including a braking assembly comprising:

a control assembly for controlling said carriage and effecting braking by said braking assembly; the control assembly operably linked to a braking mechanism capable of engaging said at least one wheel of said carriage to effect braking thereof; wherein, said braking assembly moves between a non working state in which the braking mechanism is free of said at least one wheel and a working state in which the braking mechanism engages said at least one wheel to effect braking when said carriage encounters a slope.

In another broad form the present invention comprises;

a wheel barrow including a wheel mounted undercarriage and including a receptacle for carrying materials; characterised in that the wheel barrow includes a braking assembly comprising: a braking mechanism capable of engagement with a wheel of said carriage to effect braking thereof, means operably linking said braking mechanism to an actuating member associated with said operating handle; wherein said braking assembly moves between a non working state in which the braking mechanism is free of said wheel and a working state in which the braking mechanism engages the wheel to effect braking when said wheel barrow encounters a slope. According to a preferred embodiment, the braking assembly is operably responsive to the action of gravity.

In its broadest form the present invention comprises:

a wheel barrow including a braking assembly including a control assembly operably linked to a braking mechanism for effecting braking of said wheel barrow; wherein said braking assembly is responsive to the effects of gravity on said wheel barrow when said wheel barrow negotiates a slope.

### DETAILED DESCRIPTION

The present invention will now be described according to preferred but non limiting embodiments and with reference to the accompanying illustrations wherein:

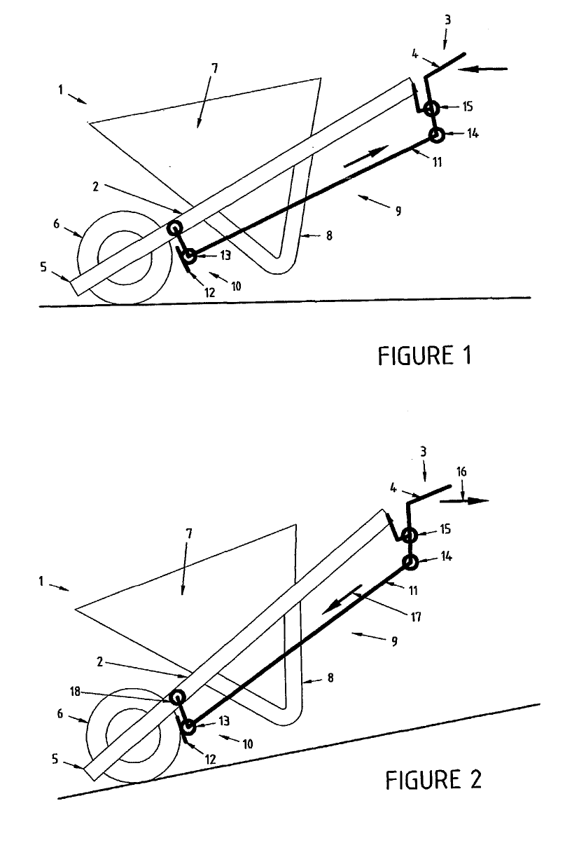

FIG. 1 shows an embodiment of the invention as applied to a wheel barrow with the braking mechanism in the non working state.

FIG. 2 shows the embodiment of FIG. 1 with the braking mechanism in a working state.

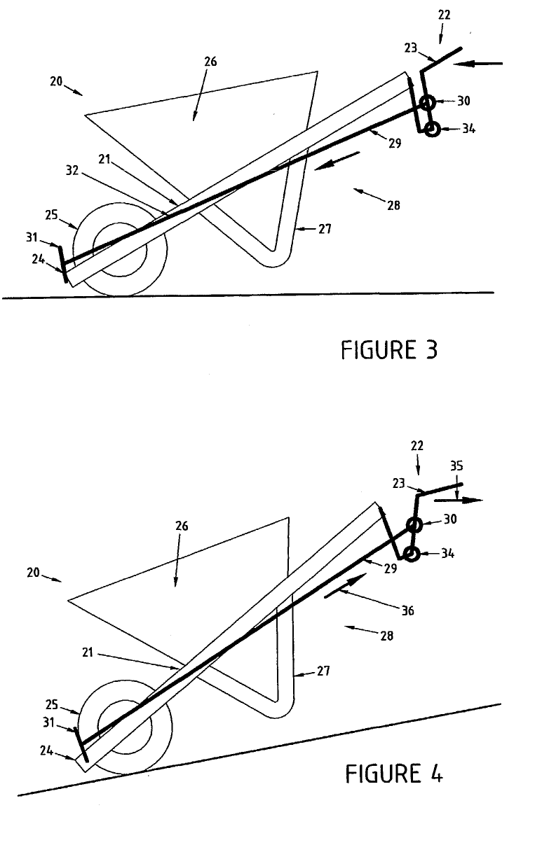

FIG. 3 shows an alternative embodiment of the invention as applied to a wheel barrow with the braking mechanism in the non working state.

FIG. 4 shows the embodiment of FIG. 3 with the braking mechanism in a working state.

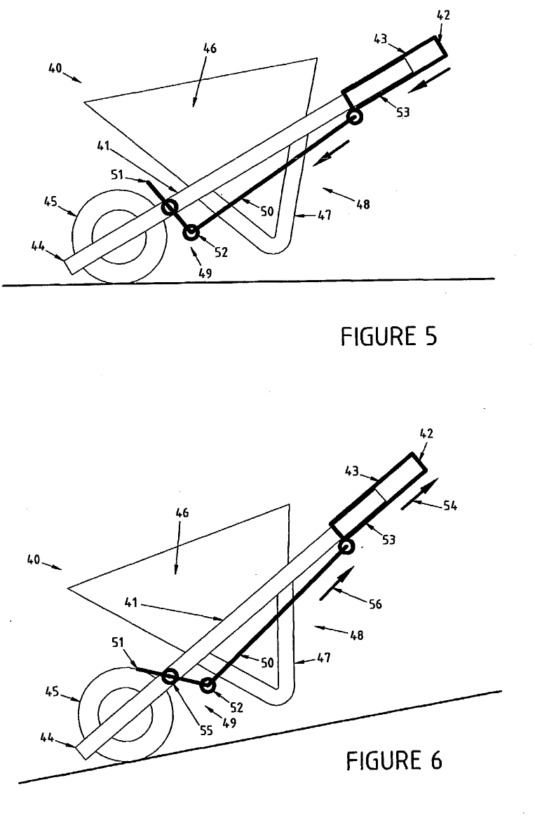

FIG. 5 shows an alternative embodiment of the invention as applied to a wheel barrow with the braking mechanism in the non working state.

FIG. 6 shows the embodiment of FIG. 5 with the braking mechanism in a working state.

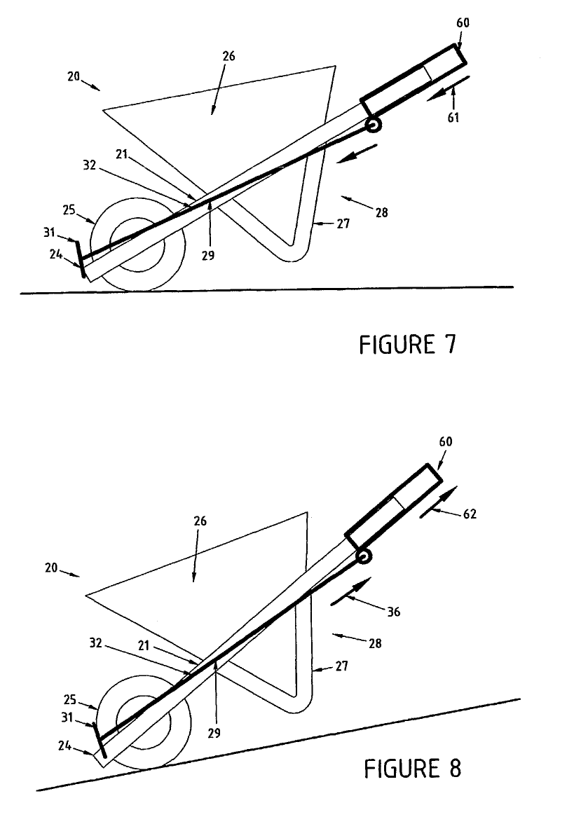

FIG. 7 shows an alternative embodiment of the invention as applied to a wheel barrow with the braking mechanism in the non working state.

FIG. 8 shows the embodiment of FIG. 7 with the braking mechanism in a working state.

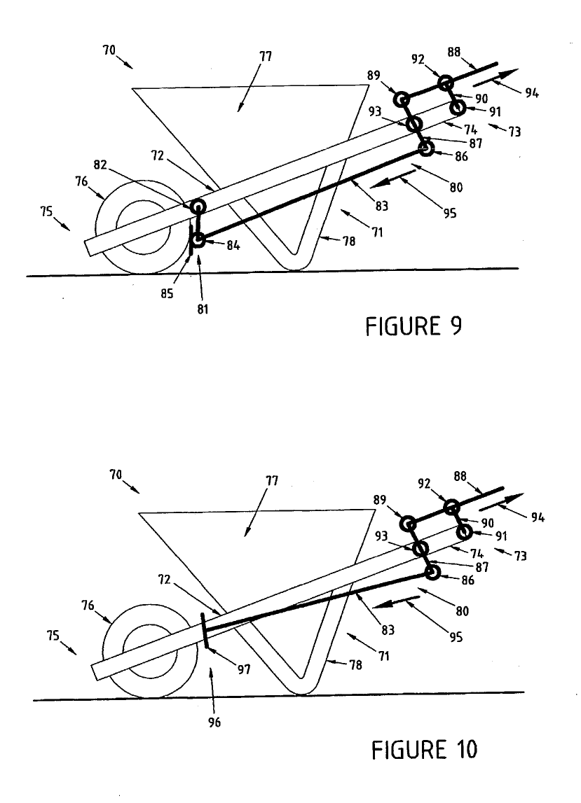

FIG. 9 shows an alternative embodiment of the invention as applied to a wheel barrow

FIG. 10 shows the embodiment of FIG. 9 with an alternative braking mechanism.

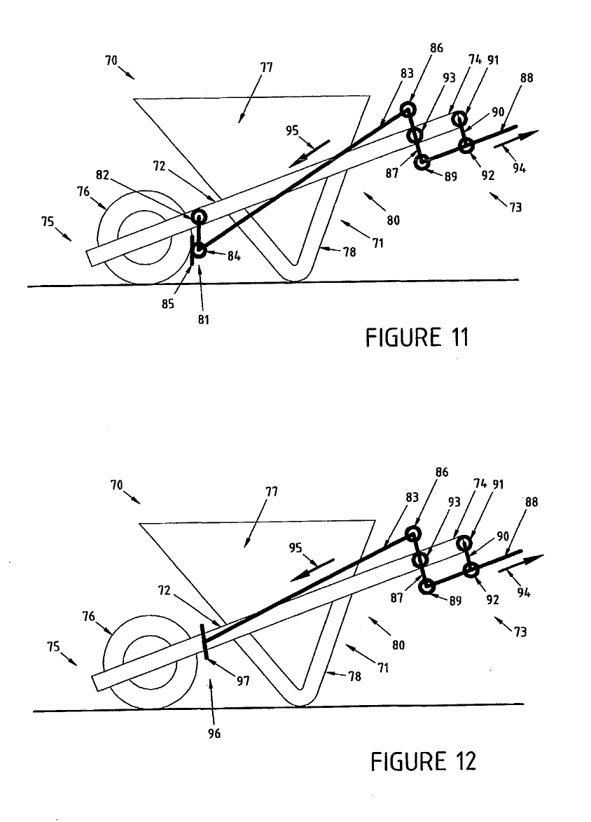

FIG. 11 shows an alternative embodiment of the invention as applied to a wheel barrow. FIG. 12 shows the embodiment of FIG. 11 with an alternative braking mechanism.

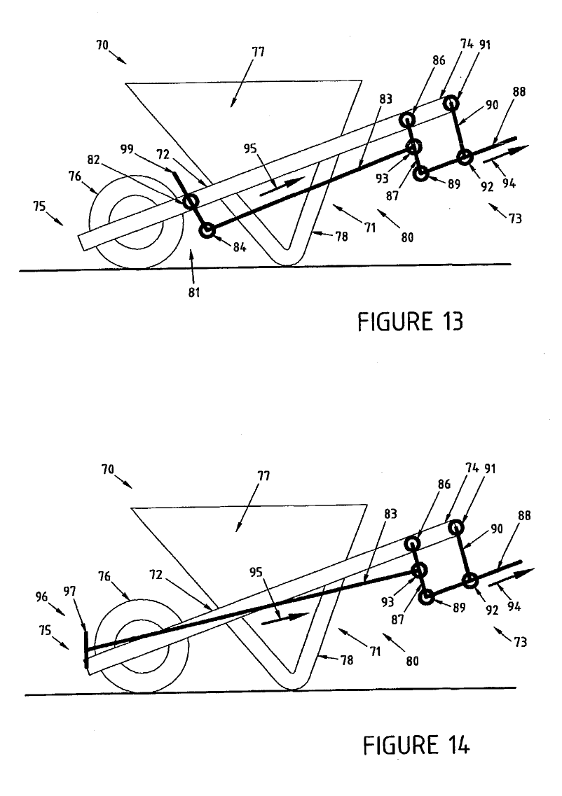

FIG. 13 shows an alternative embodiment of the invention as applied to a wheel barrow.

FIG. 14 shows the embodiment of FIG. 13 with an alternative braking mechanism.

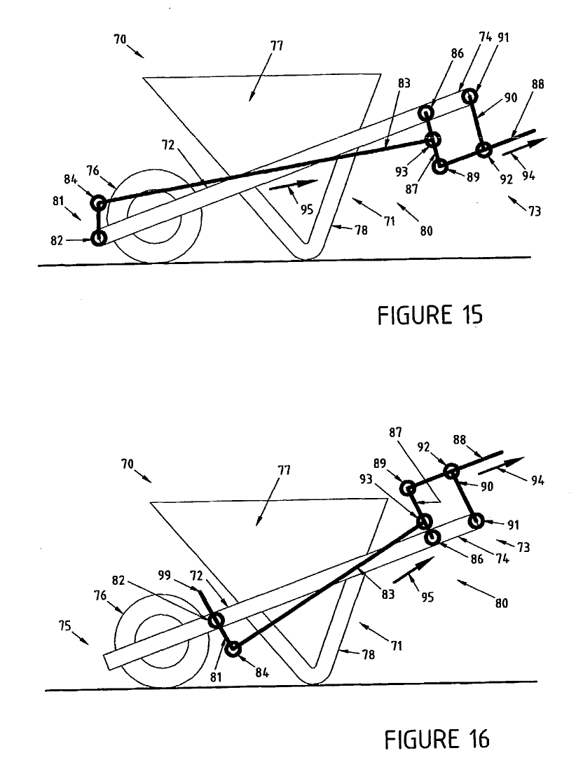

FIG. 15 shows an embodiment of FIG. 14 with alternative braking mechanism;

FIG. 16 shows an alternative the embodiment of the invention with an alternative braking mechanism.

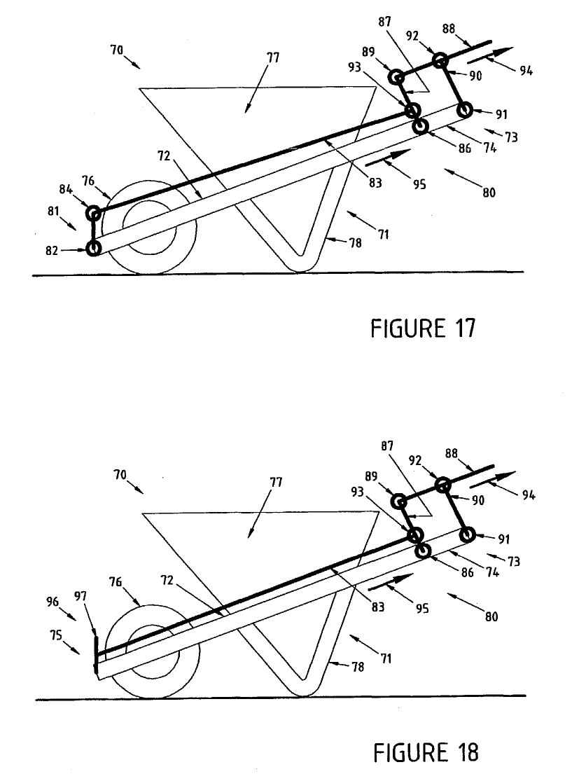

FIG. 17 shows the embodiment of FIG. 16 with alternative braking mechanism.

FIG. 18 shows an alternative embodiment of FIG. 16 with alternative braking mechanism.

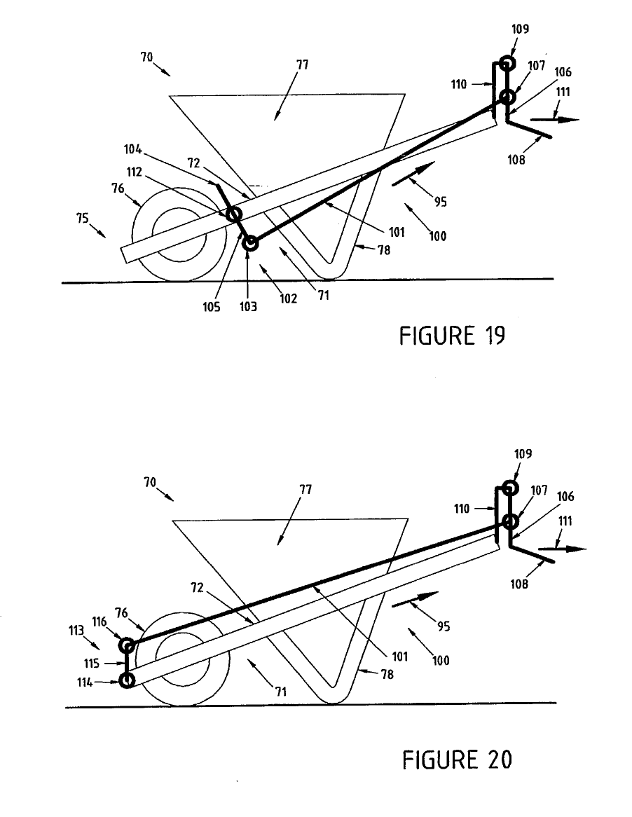

FIG. 19 shows an alternative embodiment of the invention.

FIG. 20 shows the embodiment of FIG. 19 with an alternative braking mechanism.

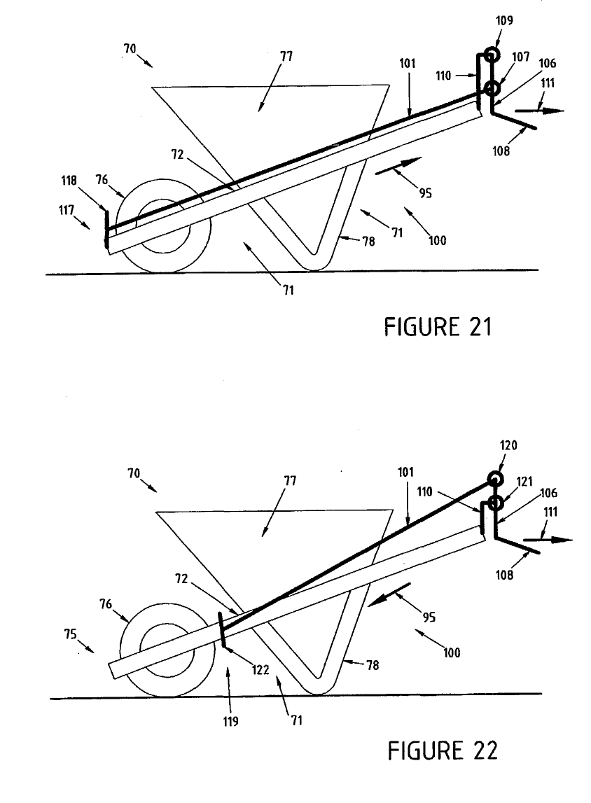

FIG. 21 shows the embodiment of FIG. 19 with an alternative braking mechanism.

FIG. 22 shows an alternative embodiment with braking mechanism.

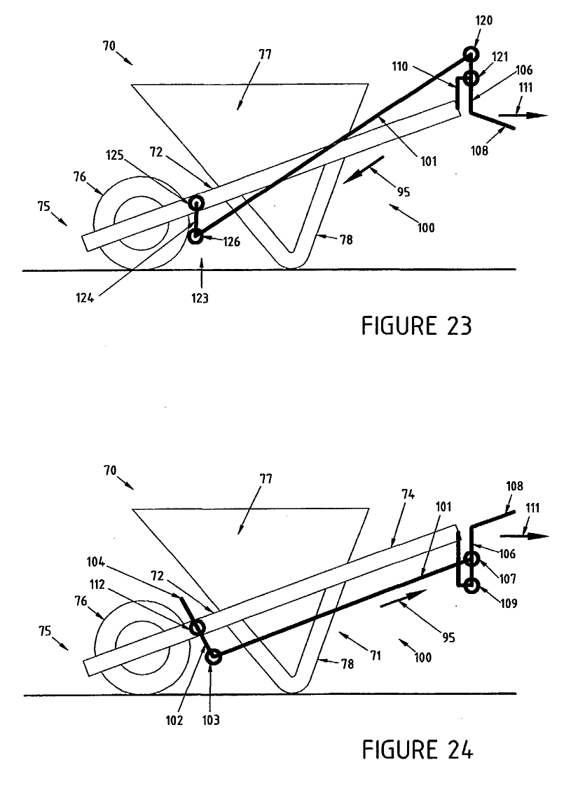

FIG. 23 shows an embodiment of the invention of FIG. 22 with alternative braking mechanism.

FIG. 24 shows an alternative embodiment of the invention as applied to a wheel barrow

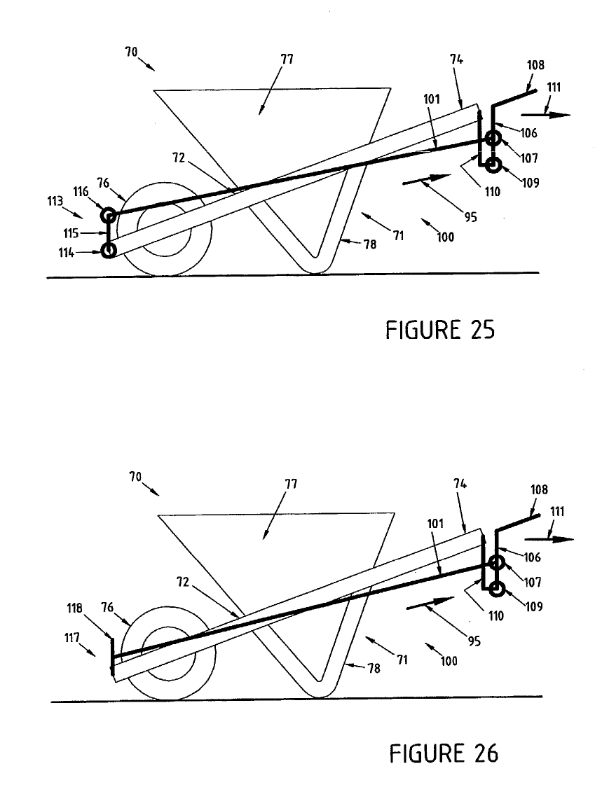

FIG. 25 shows the embodiment of FIG. 24 with an alternative braking mechanism.

FIG. 26 shows the embodiment of FIG. 25 with an alternative braking mechanism.

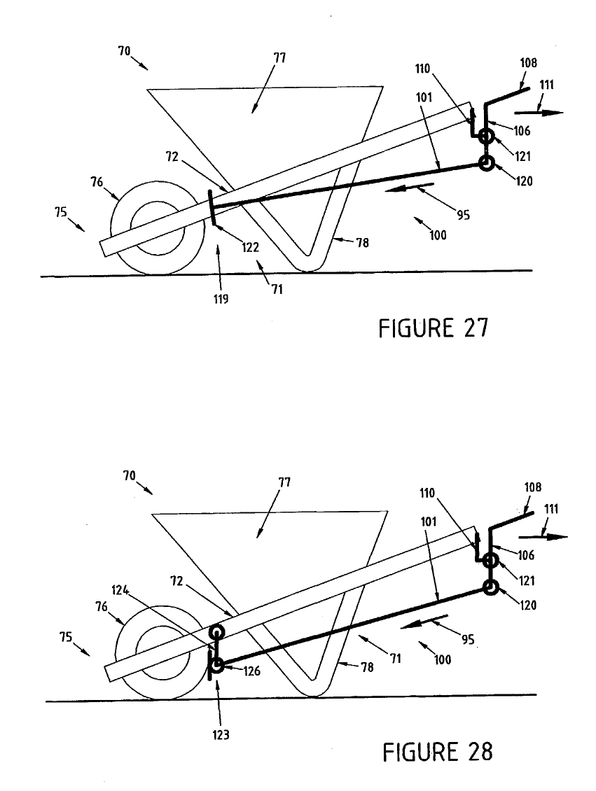

FIG. 27 shows an alternative embodiment of the braking assembly with an alternative braking mechanism.

FIG. 28 shows a braking assembly according to the embodiment of FIG. 27 with alternative braking assembly.

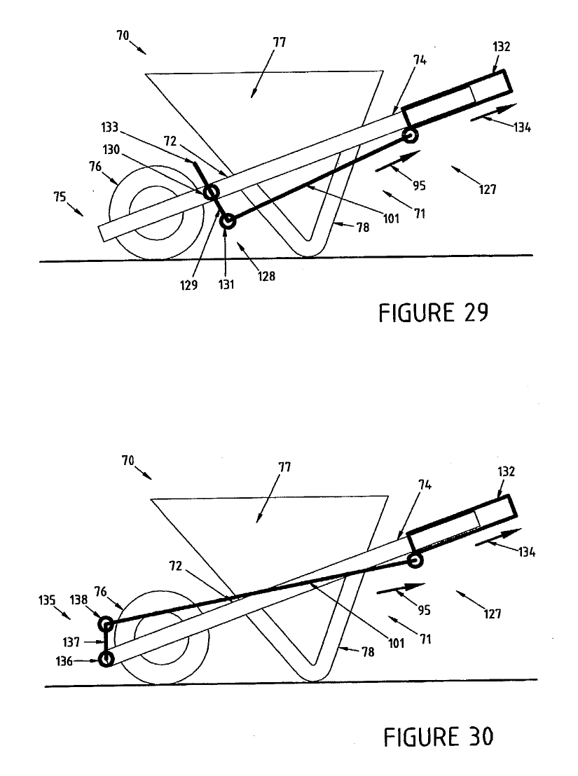

FIG. 29 shows an alternative embodiment of the invention as applied to a wheel barrow wherein each handle comprises a sleeve member.

FIG. 30 shows the embodiment of FIG. 29 with an alternative braking mechanism.

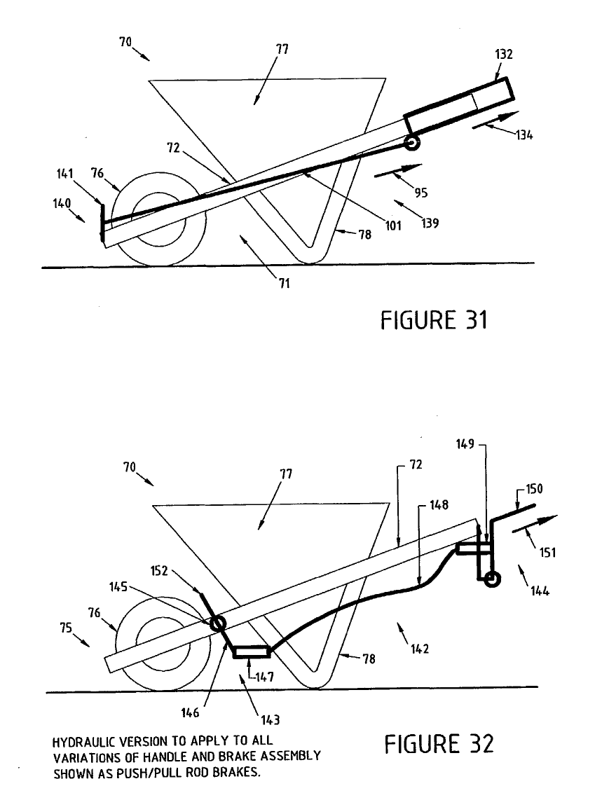

FIG. 31 shows the embodiment of FIG. 29 with an alternative braking mechanism.

FIG. 32 shows a braking assembly according to an alternative embodiment wherein the linkage between the actuating member and braking mechanism comprises a hydraulic line.

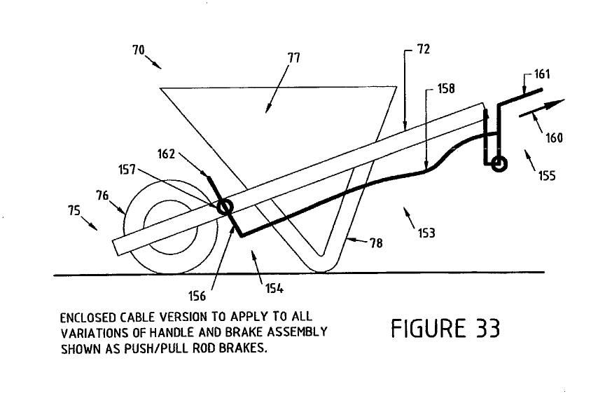

FIG. 33 shows a braking assembly according to an alternative embodiment wherein the linkage between the actuating member and braking mechanism comprises a cable.

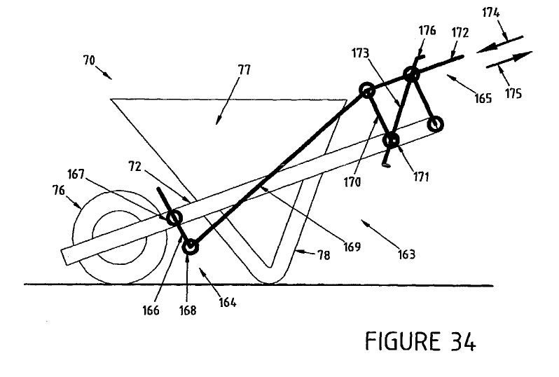

FIG. 34 shows an alternative embodiment of the braking assembly including a brake disable or enable member.

Referring to FIG. 1 there is shown an embodiment of the invention as applied to a wheel barrow with the braking mechanism in the non working state. Wheel barrow 1 comprises an undercarriage 3 which terminates at end 3 in handles 4. End 5 of undercarriage 2 is supported by wheel 6. Undercarriage 3 further includes thereon a receptacle 7 for receiving and holding articles or materials to be carried by wheel barrow 1. Undercarriage 2 further comprises downwardly depending ground engaging supports 8 which provide static support when the wheel barrow is stationary. The aforesaid describes features of a typical wheel barrow. According to one embodiment of the invention wheel barrow 1 further is characterised in having a braking assembly 9 which includes a braking mechanism 10 operably connected to handle 4 via linkage 11. FIG. 1 shows the braking assembly 9 in a non working state wherein braking mechanism 10 is free of wheel 6. Braking mechanism 10 further comprises brake pad 12 which contacts wheel 6 when the braking assembly is in the working state. Braking assembly 9 is arranged such that linkage arm 11 is pivotally connected at pivot point 13 to brake mechanism 10 and via pivot points 14 and 15.

FIG. 2 shows the embodiment of FIG. 1 with the braking mechanism in a working state. The brake mechanism 10 is actuated in response to the force of gravity on the wheel barrow which causes rotation of handle 4 about pivot point 15. When wheel barrow 1 encounters a momentum grade, the operator naturally pulls the handle 4 axially in the direction of arrow 16 thereby causing a moment about pivot 15. This causes consequential movement of linkage 11 in the direction of arrow 17 causing braking mechanism 10 to rotate about pivot 18 thereby urging pad 12 against wheel 6. Thus, braking is effected by resistance to the action of gravity by an operator.

Referring to FIG. 3 there is shown an alternative embodiment of the invention as applied to a wheel barrow with the braking assembly in the non working state. Wheel barrow 20 comprises an undercarriage 21 which terminates at end 22 in handles 23. End 24 of undercarriage 21 is supported by wheel 25. Undercarriage 21 further includes thereon a receptacle 26 for receiving and holding articles or materials to be carried by wheel barrow 20 and further comprises downwardly depending ground engaging supports 27 which provide static support when the wheel barrow is stationary. The aforesaid describes features of a typical wheel barrow. According to the embodiment of the invention shown, wheel barrow 20 is further characterised in having a braking assembly 28 which includes a braking arm 29 operably connected to handle 23 via linkage 30. FIG. 3 shows the braking assembly 28 in a non working state wherein braking pad 31 is free of wheel 25. Brake pad 31 contacts wheel 25 when the braking assembly is in the working state. Braking assembly 28 is arranged such that braking arm 29 is supported by undercarriage at conjunction 32 and is pivotally connected at pivot point 30 to handle 23.

FIG. 4 shows the embodiment of FIG. 3 with the braking mechanism in a working state. The brake assembly 28 is actuated in response to the force of gravity on the wheel barrow which causes rotation of handle 23 about pivot point 34.When wheel barrow 20 encounters a momentum grade the operator naturally pulls the handle 23 axially in the direction of arrow 35 thereby causing a moment about pivot 34. This causes consequential movement of linkage arm 29 in the direction of arrow 36 causing braking pad 31 to engage wheel 25. Thus, braking is effected by resistance to the action of gravity by an operator.

Referring to FIG. 5 there is shown an alternative embodiment of the invention as applied to a wheel barrow with the braking mechanism in the non working state. Wheel barrow 40 comprises an undercarriage 41 which terminates at end 42 in handles 43. End 44 of undercarriage 41 is supported by wheel 45 and further includes thereon a receptacle 46 for receiving and holding articles or materials to be carried by wheel barrow 40. Undercarriage 41 further comprises downwardly depending ground engaging supports 47 which provide static support when the wheel barrow is stationary. The aforesaid again describes features of a typical wheel barrow.

According to an alternative embodiment of the invention, wheel barrow 40 further is characterised in having a braking assembly 48 which includes a braking mechanism 49 operably connected to handle 43 via linkage arm 50. FIG. 5 shows the braking assembly 48 in a non working state wherein braking mechanism 49 is free of wheel 45. Braking mechanism 49 further comprises brake pad 51 which contacts wheel 45 when the braking assembly is in the working state. Braking assembly 48 is arranged such that linkage arm 50 is pivotally connected at pivot point 52 to brake mechanism 49 and at its other end to sleeve handle 53.

FIG. 6 shows the embodiment of FIG. 5 with the braking mechanism in a working state.

The brake mechanism 49 is actuated in response to the force of gravity on the wheel barrow which causes relative movement of sleeve 53 in the direction of arrow 54. When wheel barrow 40 encounters a momentum grade the operator naturally pulls sleeve 43 axially in the direction of arrow 54 to resist acceleration of the barrow thereby causing a moment about pivot 55 due to the movement of linkage arm 50 in the direction of arrow 56. This urges pad 51 against wheel 45. Thus, braking is effected by action of gravity on the wheel barrow and by resistance to the action of gravity by an operator.

Referring to FIG. 7 there is shown an alternative embodiment of the invention as applied to a wheel barrow with the braking assembly in the non working state. The arrangement in FIGS. 7 and 8 is similar to that shown in FIGS. 3 and 4 and has been numbered in accordance with FIGS. 3 and 4. According to the embodiment of the invention shown wheel barrow 20 is characterised in that instead of employing pivoting handle 23 it includes sleeve 60 which is capable of sliding movement in the direction of arrow 61. FIG. 7 shows the braking assembly 28 in a non working state wherein braking pad 31 is free of wheel 25. Brake pad 31 contacts wheel 25 when the braking assembly is in the working state. Braking assembly 28 is arranged such that braking arm 29 is supported by undercarriage at conjunction 32.

FIG. 8 shows the embodiment of FIG. 7 with the braking mechanism in a working state. The brake assembly 28 is actuated in response to the force of gravity on the wheel barrow which causes sliding of sleeve 60 in the direction of arrow 62. When wheel barrow 20 encounters a momentum grade the operator naturally pulls the sleeve 60 axially in the direction of arrow 62 thereby causing a consequential movement of linkage arm 29 in the direction of arrow 36 causing braking pad 31 to engage wheel 25. Thus, braking is effected by resistance to the action of gravity by an operator. The braking assembly may be retro fitted to existing carriages.

### ALTERNATIVE EMBODIMENTS

FIGS. 9-34 show a range of braking assembly configurations each fitted to a schematic representation of a typical wheel barrow. Wheel barrow 70 comprises an undercarriage 71 which includes support platform 72 terminating at end 73 in handle 74. Support platform 72 will normally terminate in two spaced apart handles. Opposite end 75 of undercarriage 71 is supported by wheel 76. Undercarriage 71 further includes thereon a receptacle 77 for receiving and holding articles or materials to be carried by wheel barrow 70. Undercarriage 71 further comprises downwardly depending ground engaging supports 78 which provide static support when the wheel barrow is stationary. The aforesaid describes features of a typical wheel barrow common to each of the embodiments shown in FIGS. 9-34.

The embodiments of FIGS. 9-34 will now be described with reference to alternative braking assemblies as shown.

Referring to FIG. 9 there is shown an embodiment of the invention as applied to a wheel barrow. Braking assembly 80 includes a braking mechanism 81 which is anchored to support platform 71 via pivot 82 and to linkage rod 83 via pivot 84. Braking mechanism 81 further comprises brake shoe 85 which contacts wheel 76 when the braking assembly is in the working state. Braking assembly 80 is arranged such that linkage arm 83 is pivotally connected at pivot point 84 to brake mechanism 81 and via pivot 86 to actuating member 87. Actuating member 87 is connected to auxiliary handle 88 via pivot 89. Handle 88 is connected via support arm 90 to handle 74 via pivots 91 and 92. Actuating member 87 is adapted to rotate about pivot 93 on handle 74. In operation, when braking is to be effected, handle 88 is urged in the direction of arrow 94 to counteract the effect of gravity acting on a load in receptacle 77 when wheel barrow 70 is operating on a slope. This action causes brake shoe 85 to be urged against the surface of wheel 76 as linkage rod 83 is urged in the direction of arrow 95 responsive to the action of handle 88. In this case, actuating member 87 and support arm 90 will move in unison.

FIG. 10 shows the braking assembly of FIG. 9 with alternative brake mechanism 96. In this case linkage rod 83 traverses a path which enables pad 97 to engage wheel 76 at a central location. The remaining part of the braking assembly operates as described for the embodiment of FIG. 9.

FIG. 11 shows an alternative embodiment of a braking assembly of FIG. 9 with handle 88 reversed below handle 74. FIG. 12 shows the assembly of FIG. 11 with alternate braking mechanism 96.

FIG. 13 shows brake assembly 80 according to an alternative embodiment of the invention. In this embodiment, actuating member 87 is affixed to support platform 72 via pivot 86. linkage rod 83 engages actuating member 87 via pivot 93 and handle 88 via pivot 89. In this embodiment. As handle 88 is urged in the direction of arrow 94 linkage rod also travels in the same direction which causes free end 99 to rotate towards wheel 76 to effect braking.

FIG. 14 shows a braking assembly similar to that of FIG. 13 except that the braking mechanism 97 is disposed forward of wheel 76, such that as handle 88 is urged in the direction of arrow 94 brake shoe 97 engages the front extremity of wheel 76. FIG. 15 shows a braking assembly similar to embodiment of FIG. 13 except that the braking mechanism 81 is disposed forward of and engages the front of wheel 76.

FIG. 16 discloses a similar braking assembly as shown in FIG. 13 except that handle 88 is shown in the mirror image position above support platform 71.

FIG. 17 discloses a similar braking assembly as shown in FIG. 15 except that handle 88 is shown in the mirror image position above support platform 71.

FIG. 18 discloses a similar braking assembly as shown in FIG. 14 except that handle 88 is shown in the mirror image position above support platform 71.

FIG. 19 shows a brake assembly according to an alternative embodiment. The assembly 100 comprises a linkage rod 101 connected at a first end to a braking mechanism 102 which comprises a pivot connection 103 which engages linkage rod 101 and pivot anchorage 112. Free end 104 of braking arm 105 engages wheel 76 when rod 101 is urged in the direction of arrow 95. Opposite end of rod 101 is connected to an actuating member 106 via pivot 107. Actuating member 106 terminates in handle 108. Actuating member 106 is connected at its opposite end via pivot 109 to bracket 110 which itself is connected to platform 72. As handle 108 is urged in the general direction of arrow 111 this urges linkage rod 101 in the direction of arrow 95 which in turn activates braking mechanism 102. As linkage rod 101 is urged in the direction of arrow 95 braking arm is caused to pivot about pivot 103 whereupon free end 104 is urged into contact with wheel 76 with the degree of contact dictated by gravitational effects on wheel barrow 70. FIG. 20 shows a further embodiment of a braking assembly 100 with an alternative braking mechanism 113, comprising anchorage 114 and braking arm 115 which is connected to linkage rod 101 via pivot 116.

FIG. 21 shows an alternative embodiment of the braking assembly 100 with alternative braking mechanism 117, which includes brake shoe 118. When handle 108 is urged in the direction of arrow 111, brake shoe 118 is urged against the front of wheel 76 with the amount of braking governed by the gravitational effects acting on the wheel barrow 70.

FIG. 22 shows a variation of the general arrangement shown in FIG. 21 with an alternative braking mechanism 119. The embodiment shows handle 108 linked to linkage rod 101 via pivot 120. Actuating arm 106 is supported at bracket 110 at connection 121 abbreviated to clear the operating region of rod 101. When handle 108 is urged in the direction of arrow 111 this causes rod 101 to advance in the direction of arrow 95, thereby urging shoe 122 onto the surface of wheel 76.

FIG. 23 shows a variation of the embodiment of FIG. 22 with alternative braking mechanism 123. Braking mechanism 123 comprises braking arm 124 which is anchored to platform 72 via connector 125 and joined to linkage rod 101 via pivot 126.

FIG. 24 is a variation of the arrangement of FIG. 19 with the handle 108 in mirror image disposition about handle 74. The mechanics of the braking assembly 100 are otherwise identical to that described for FIG. 19. FIG. 25 is a variation of the arrangement of FIG. 20 with the handle 108 mirror image disposition about handle 74.

The mechanics of the braking assembly 113 are otherwise identical to that described for FIG. 20.

FIG. 26 is a variation of the arrangement of FIG. 21 with the handle 108 in mirror image disposition. The mechanics of the braking assembly 117 are otherwise identical to that described for FIG. 21. FIG. 27 is a variation of the arrangement of FIG. 22 with the handle 108 in mirror image disposition. The mechanics of the braking assembly 119 are otherwise identical to that described for FIG. 22. FIG. 28 is a variation of the arrangement of FIG. 23 with the handle 108 in mirror image disposition. The mechanics of the braking assembly 123 are otherwise identical to that described for FIG. 23. FIG. 29 shows an alternative braking assembly 127 incorporating braking mechanism 128. The brake mechanism 128 includes braking arm 129 which is attached at one end to platform 72 via anchorage 130. Arm 129 engages rod 101 via pivot 131. Rod 101 is attached to sleeve 132 which is adapted to slide relative to handle 74. Sleeve 132 slides relative to handle 74 under the action of gravity on the wheel barrow which causes relative movement of sleeve 132 in the direction of arrow 134. When wheel barrow 70 encounters a momentum grade the operator naturally pulls sleeve 132 axially in the direction of arrow 134 to resist acceleration of the barrow thereby causing a moment about anchorage 130 due to the movement of linkage arm 101 in the direction of arrow 95. This urges free end 133 of arm 129 against wheel 76. Thus, braking is effected by resistance to the action of gravity by an operator.

FIG. 30 shows a brake assembly 127 similar to that shown in FIG. 29 with an alternative braking mechanism 135. Braking mechanism 135 includes braking arm 137 which is attached at one end via anchorage 138. Arm 137 is also attached to linkage rod 101 via pivot 138. Thus, braking is effected by resistance to the action of gravity by an operator.

FIG. 31 shows a brake assembly 139 similar to that shown in FIG. 29 with an alternative braking mechanism 140. Braking mechanism 140 includes brake shoe 141 which is attached to rod 101.

FIG. 32 shows a braking assembly 142 according to an alternative embodiment of the invention. The assembly shown comprises a braking mechanism 143 and handle assembly 144. Braking mechanism 143 comprises a braking arm 146 which is pivotally connected to platform 72 at anchorage 145. Braking arm 146 is connected to hydraulic slave cylinder 147 which is operably connected to hydraulic line 148. Hydraulic line 148 is connected to master cylinder 149 which is connected to handle 150. movement of handle 150 in the direction of arrow 151 causes slave hydraulic cylinder 147 to urge free end 152 of braking arm 146 against wheel 76 thereby effecting braking. As for the previous embodiments described, when wheel barrow 70 is subject to gravitational effects induced by an incline a counteracting force induced by handle 150 urged in the direction of arrow 151 urges free end 152 against wheel 76.

FIG. 33 shows a further embodiment of the invention with alternative braking assembly 153, comprising braking mechanism 154 and handle assembly 155. Braking mechanism 154 includes braking arm 156 mounted on platform 72 at anchorage 157. Braking arm 156 engages cable 158 which is linked at its other end to handle assembly 155. When handle 161 is urged in the direction of arrow 160 cable 158 urges free end 162 of braking arm 156 in the direction of wheel 76 to thereby effect braking of wheel barrow 70.

FIG. 34 shows an alternative embodiment of a braking assembly. Braking Assembly 163 includes a braking mechanism 164 and a handle assembly 165. Braking assembly 163 includes braking arm 166 which is attached to platform 72 at pivot 167. Arm 166 is attached at pivot 168 to linkage rod 169. Handle assembly 165 includes an actuating arm 170 which is attached to platform 72 at pivot 171. Handle 172 is joined to disable/enable strut 173 which when engaged resists unwanted forward or reverse movement of handle 172 in the directions of either arrows 174 or 175. When engaged, strut 173 locks the handle assembly 165 and particularly handle 172 in the directions of arrows 174 and 175 to prevent unwanted relative movement between handle 172 and platform 72. This ensures positive control over wheel barrow 70 in circumstances when braking is required and not required. When wheel barrow 70 encounters a momentum grade the operator may release strut 173 via lever 176 to activate natural braking by braking assembly 163. Each of the embodiments described above may include a release mechanism which activates or de activates a braking assembly.

According to one embodiment braking arm 166 may comprise a flat plate which opposes the wheel tread and engages the tread to effect braking.

The above described braking assemblies may be retro fitted to existing carriages and wheel barrows.

It will be recognised by persons skilled in the art that numerous variations and modifications may be made to the invention as broadly described herein without departing from the overall spirit and scope of the invention.

The claims defining the invention are as follows:

1. A braking assembly for a hand operated wheel mounted carriage, the carriage including a support structure comprising a platform for receiving and supporting a load, an undercarriage including at least one wheel; the braking assembly comprising:
a control assembly for controlling said carriage and effecting braking by said braking assembly; the control assembly operably linked to a braking mechanism capable of engaging said at least one wheel of said carriage to effect braking thereof; wherein, said braking assembly moves between a non working state in which the braking mechanism is free of said at least one wheel and a working state in which the braking mechanism engages said at least one wheel to effect braking when said carriage encounters a slope.

2. A braking assembly according to claim 1 wherein the braking assembly is responsive to the effects of gravity generated by a slope.

3. A braking assembly according to claim 2 wherein said control assembly includes an actuating member which is capable of movement relative to said support platform.

4. A braking assembly according to claim 3 wherein movement of said actuating member relative to said support platform is promoted by the action of gravity on said carriage.

5. A braking assembly according to claim 4 wherein the actuating member is operably connected to said braking mechanism via a linkage capable of transferring an input into said control assembly to said braking mechanism.

6. A braking assembly according to claim 5 wherein said actuating member transmits said input from said control assembly to said braking mechanism via said linkage.

7. A braking assembly according to claim 6 wherein said control assembly includes a handle which cooperates with said actuating member.

8. A braking assembly according to claim 7 wherein said control assembly operates in response to movement of said handle in a first direction relative to said platform thereby effecting movement of said linkage in a second direction relative to said platform.

9. A braking assembly according to claim 8 wherein said first direction is opposite to a direction of travel of said carriage when in use.

10. A braking assembly according to claim 9 wherein said second direction of travel of said linkage may be the same as or an opposite direction to the direction of travel of said carriage.

11. A braking assembly according to claim 10 wherein said actuating member is connected to one or both said gripping handles.

12. A braking assembly according to claim 11 wherein said actuating member moves in unison with said gripping handles and relative to said support platform.

13. A braking assembly according to claim 12 wherein said braking mechanism includes a braking arm which transmits input from said actuating member to a braking force in said least one wheel.

14. A braking assembly according to claim 13 wherein said linkage includes a link member which at one extremity engages said actuating member and at an opposite extremity engages said braking member.

15. A braking assembly according to claim 14 wherein said actuating member rotates relative to said platform.

16. A braking assembly according to claim 15 wherein said actuating member contributes to the support of said carriage.

17. A braking assembly according to claim 16 wherein said actuating member forms all or part of support legs for said support structure.

18. A braking assembly according to claim 17 wherein said actuating member rotates relative to said support to activate said braking.

19. A braking assembly according to claim 18 wherein said linkage moves with said actuating member.

20. A braking assembly according to claim 14 wherein the actuating member comprises at least one sleeve which engages one or both said gripping handles and is adapted to slidably move relative thereto.

21. A braking assembly according to claim 20 wherein said at least one sleeve is linked to said braking mechanism via said linkage.

22. A braking assembly according to claim 21 wherein the braking mechanism is actuated by relative movement between said at least one sleeve and said handles.

23. A braking assembly according to claim 22 wherein there are two sleeves one on each gripping handle, the sleeves cooperating with said braking mechanism to effect braking of said carriage by rearward movement relative to said handles.

24. A braking assembly according to claim 23 wherein the braking mechanism is linked to said sleeves via a linkage rod.

25. A braking assembly according to claim 14 wherein said braking member includes a brake shoe.

26. A braking assembly according to claim 25 wherein said braking mechanism is connected to said platform.

27. A braking assembly according to claim 26 wherein said braking arm rotates relative to said platform to engage said brake show with said wheel.

28. A braking assembly according to claim 27 wherein the braking mechanism engages a wheel hub.

29. A braking assembly according to claim 7 wherein the linkage comprises a master hydraulic cylinder attached to said actuating member and a slave hydraulic cylinder attached to said braking mechanism, wherein said master cylinder and slave cylinders communicate via a hydraulic hose, such that an input to said actuation member is transferred via said cylinders to said braking arm to effect said braking.

30. A braking assembly according to claim 7 wherein the linkage comprises a linkage rod joined at one end to said actuating arm and at the other end to said braking arm.

31. A braking assembly according to claim 7 wherein said linkage comprises a cable joined at one end to said actuating arm and at the other end to said braking arm.

33. A hand operated wheel mounted carriage, the carriage including a support structure comprising a platform for receiving and supporting a load, an undercarriage including at least one wheel; the carriage further including a braking assembly comprising:
a control assembly for controlling said carriage and effecting braking by said braking assembly; the control assembly operably linked to a braking mechanism capable of engaging said at least one wheel of said carriage to effect braking thereof; wherein, said braking assembly moves between a non working state in which the braking mechanism is free of said at least one wheel and a working state in which the braking mechanism engages said at least one wheel to effect braking when said carriage encounters a slope.

34. A carriage according to claim 33 wherein the braking assembly is operatively responsive to the effects of gravity generated by a slope.

35. A carriage according to claim 34 wherein said control assembly includes an actuating member which is capable of movement relative to said support platform.

36. A carriage according to claim 35 wherein movement of said actuating member relative to said support platform is promoted by the action of gravity on said carriage.

37. A carriage according to claim 36 wherein the actuating member is operably connected to said braking mechanism via a linkage capable of transferring an input into said control assembly to said braking mechanism.

38. A carriage according to claim 37 wherein said actuating member transmits said input from said control assembly to said braking mechanism via said linkage.

39. A carriage according to claim 38 wherein said control assembly includes a handle which cooperates with said actuating member.

40. A carriage according to claim 39 wherein said control assembly operates in response to movement of said handle in a first direction relative to said platform thereby effecting movement of said linkage in a second direction relative to said platform.

41. A carriage according to claim 40 wherein said first direction is opposite to a direction of travel of said carriage when in use.

42. A carriage according to claim 41 wherein said second direction of travel of said linkage may be the same as or an opposite direction to the direction of travel of said carriage.

43. A carriage according to claim 42 wherein said actuating member is connected to one or both said gripping handles.

44. A carriage according to claim 43 wherein said actuating member moves in unison with said gripping handles and relative to said support platform.

45. A carriage according to claim 44 wherein said braking mechanism includes a braking arm which transmits input from said actuating member to a braking force in said at least one wheel.

46. A carriage according to claim 45 wherein said linkage includes a link member which at one extremity engages said actuating member and at an opposite extremity engages said braking member.

47. A carriage according to claim 46 wherein said actuating member rotates relative to said platform.

48. A carriage according to claim 47 wherein said actuating member contributes to the support of said carriage.

49. A carriage according to claim 48 wherein said actuating member forms all or part of support legs for said support structure.

50. A carriage according to claim 49 wherein said actuating member rotates relative to said support to activate said braking.

51. A carriage according to claim 50 wherein said linkage moves with said actuating member.

52. A carriage according to claim 46 wherein the actuating member comprises at least one sleeve which engages one or both said gripping handles and is adapted to slidably move relative thereto.

53. A carriage according to claim 52 wherein said at least one sleeve is linked to said braking mechanism via said linkage.

54. A carriage according to claim 53 wherein the braking mechanism is actuated by relative movement between said at least one sleeve and said handles.

55. A carriage according to claim 54 wherein there are two sleeves one on each gripping handle, the sleeves cooperating with said braking mechanism to effect braking of said carriage by rearward movement relative to said handles.

56. A carriage according to claim 55 wherein the braking mechanism is linked to said sleeves via a linkage rod.

57. A carriage according to claim 56 wherein said braking member includes a brake shoe.

58. A carriage according to claim 57 wherein said braking mechanism is connected to said platform.

59. A carriage according to claim 58 wherein said braking arm rotates relative to said platform to engage said brake show with said wheel.

60. A carriage according to claim 59 wherein the braking mechanism engages a wheel hub.

61. A carriage according to claim 39 wherein the linkage comprises a master hydraulic cylinder attached to said actuating member and a slave hydraulic cylinder attached to said braking mechanism, wherein said master cylinder and slave cylinders communicate via a hydraulic hose, such that an input to said actuation member is transferred via said cylinders to said braking arm to effect said braking.

62. A carriage according to claim 39 wherein the linkage comprises a linkage rod joined at one end to said actuating arm and at the other end to said braking arm.

63. A carriage braking assembly according to claim 39 wherein said linkage comprises a cable joined at one end to said actuating arm and at the other end to said braking arm.

64. A carriage according to claim 63 wherein said control assembly includes a control mechanism to enable or disengage braking by said braking mechanism.

65. A carriage according to claim 1 or 33 wherein said carriage is a wheel barrow.

66. A wheel barrow including a braking assembly including a control assembly operably linked to a braking mechanism for effecting braking of said wheel barrow; wherein said braking assembly is responsive to the effects of gravity on said wheel barrow as said wheel barrow negotiates a slope.

67. A wheel barrow according to claim 66 wherein the braking assembly includes means to engage and disengage braking by said braking assembly.

68. A wheel barrow according to claim 33 wherein the braking assembly includes means to enable engagement and disengagement of braking by said braking assembly.

69. A braking assembly according to claim 1 wherein the control assembly includes means to enable engagement and disengagement of said braking mechanism.

70. A braking assembly according to claim 69 wherein the braking mechanism includes a braking arm comprising a plate which engages the outer surface of said at least one wheel.
